(19) United States
(12) Patent Application Publication
(10) Pub. No.: US 2005/0278353 A1
(43) Pub. Date: Dec. 15, 2005

(54) XML schema tool

(75) Inventors: Anders Kaare Norgaard, Holte (DK); Jan Bartold, Klampenborg (DK); Lars Pedersen, Copenhagen (DK)

Correspondence Address: Donald S. Dowden;Cooper & Dunham LLP, 1185 Avenue of the Americas, New York, NY, 10036, US

(73) Assignee: ResultMaker A/S

(21) Appl. No.: 10/860,832

(22) Filed: Jun. 2, 2004

(51) Int. Cl. G06F 7/00

(52) U.S. Cl. 707/100

(57) ABSTRACT

A method of entering, structuring, storing and transferring data using a hierarchical data model and flat forms. The method includes the following three steps, which typically are performed during the design phase: Selecting a first form from a plurality of forms, alternatively creating said first form by use of a form tool, said first form comprising a number of fields, each having an individual field name, obtaining a field name list from a hierarchical data model, where the field names of the field name list contain information on the data types for the fields of said first form as well as hierarchical information, said field names being defined in accordance with a predefined naming convention, and creating by use of the form tool and the information in the field name list the HTML-code for displaying said first form in an HTML browser. The method also includes the following two steps, which typically are applied by at run time by a user: entering data field values into the data fields of said first form, where the data field values are stored with the hierarchical information of the field names in their names, and producing an instance with data from the data field values in a hierarchical structure using a structurizer, where the hierarchical structure is determined from the field names. The method according to the invention further includes obtaining an XML schema document from the hierarchical data model, where the XML schema document includes the expected XML schema for the instance, and parsing with the use of a parser for mutual inconsistencies between the XML schema and the instance and outputting an error message if the instance does not have the expected structure.

### FIELD OF THE INVENTION

The invention relates to the conversion, exchange and structuring of data between a great number of entry points and especially the handling of information from forms and the like used in organizations such as governments, industries and so fort. The invention further relates to the preservation of hierarchical information while using a flat data structure.

### BACKGROUND ART

Data models are tools that can be used for describing the world. Consider for example a house. This house has a number of attributes, such as the address, the size, the number of rooms and so forth. All these attributes in combination are unique to this house and together they describe the house with a required level of detail. Therefore, such data models—in order to reflect the real world—are hierarchical in nature; this house has this address, this house has this number of rooms, etc.

On the other hand, when data is entered using the data model (the number of rooms is 5; the address is Sunflower street No. 7), this is usually performed without any knowledge of the data model and in most cases any information regarding the data model would be unwanted, since such an information load would complicate the collection of data. Forms and other interacting interfaces such as buttons, sliders and browsing tools for selecting data files in the form of raw data, pictures or the like are used for data collection in an inherently flat nature, where the individual fields in the form are used for the collection of form fields. The form fields are inherently flat and do not contain any interrelated information and therefore can be regarded as a flat list of information.

In order to gather hierarchical data through forms, a hierarchical naming convention is often used. In this hierarchical naming convention, the hierarchy of the data may be deduced from the structure of the names. Many schemes can be applied, where the hierarchical structure retrieves codes from the form fields, thereby mapping the hierarchy to the codes in the structure.

The advantages of a hierarchical naming convention are the possibilities for a global naming convention, a decentralized naming maintenance, the nature of the data, persistency for groups of data, etc.

There exist several tools for describing hierarchical information. An example is XML (eXtensible Markup Language) with the use of XML schemas, which are excellent for mapping structures and semi-structured information. XML is a well-known language for this purpose and the advantages of using such a language will not be described in any detail, since it will be well-known to a specialist within the technical field.

The problem when collecting data is inter alia to maintain consistency between the hierarchical data model through the flatness of the form to the hierarchical instance of data produced by the form tool.

No data model will ever stay the same, so part of the problem will also be the construction and maintenance of the data model, in particular while simultaneously enforcing consistency trough a flat form format. The task also grows in complexity with the number of data elements as a function of N1 (“N factorial”). The element number, N, may potentially interact with any of the remaining N-1 elements.

Therefore, it becomes unmanageable to maintain each element in disparate files. If a name is changed during the building of the model, the references to the corresponding element fail. This is often resolved in the XML schema world by enforcing a “No Name Change”-policy. Once a name has been given to an element or a type, this name never changes. This restriction, however, can be interfering with the practical building of data models, since multiple parties may need to be heard during the naming process. In the same way, names that at one time appear logical may due to a change appear misleading at a later time. The names can therefore be changed in the construction period of the model, and only afterwards the names can be locked. This, however, results in time-consuming revisions, where the names are changed, but where the actual functionality of the model remains the same.

A data model rarely, if ever, covers the entire universe and all systems dealing with the corresponding data elements. Interfaces to other data models representing the same data, parts of it or additional data are therefore also needed. Data in one hierarchical model may therefore be transformed fully or in part to another data model and this data model may or may not be hierarchical. This also produces a need for mapping between the different systems.

Likewise, with regard to maintenance of the data model, a method is required for automatically updating the mapping (like the aforementioned need to keep consistency with the form tool etc.). Systems often require a static naming convention and manual work for updating mapping tables is required. This is also time consuming, impractical and expensive.

When a hierarchical data model is applied, it can be used to construct a naming convention in such a way that any piece of information (any data element) gets its own global name. Identical pieces of data can thereby be recognized across systems applying the same data model, thereby implicitly integrating the systems.

In order to ensure this integration in form tools, the convention of naming the form fields must respect the above-mentioned requirement to uniquely identify the same element of data. This also applies to all other flat interfaces.

U.S. patent application 2003/0204511 A1 discloses how two different structures for related databases containing partly the same information can be mapped using XML and where XML schemas are used as the common definition for the same information. Therefore, this patent represents the general idea of using XML defined in XML schemas for representing hierarchical data when these are transferred between relational databases. However, it does not resolve the issue of having to represent the data in a flat format such as a form, where the fields inherently are not subordinated to one another.

EP 1089195 A1 discloses a method for storing and retrieving data in a database without converting it to a relational structure, while simultaneously keeping the XML instance as it is and storing it as one database element in full. XML schemas (and their equivalents) are used as means to represent the structure of the data in each field. The patent, however, does not cover the situation, where the data within the XML instance has to be represented in a flat format such as a form, where each piece of data in the XML instance must be stored and represented separately with the name of the field carrying the information on the hierarchical structure.

It is an object of the invention to provide the user with a tool to create consistent data models underlying a system, where forms and other data collecting devices can collect data and convert it to the correct hierarchy while recognizing data that already has been collected.

According to the invention, the object is obtained by a method of entering, structuring, storing and transferring data using a hierarchical data model and flat forms including:
[Typically at design time, applied by a designer user:]
   selecting a first form from a plurality of forms, alternatively creating said first form by use of a form tool, said first form comprising a number of fields, each having an individual field name,
   obtaining a field name list from a hierarchical data model, where the field names of the field name list contain information on the data types for the fields of said first form as well as hierarchical information, said field names being defined in accordance with a predefined naming convention,
   creating by use of the form tool and the information in the field name list the HTML-code for displaying said first form in an HTML browser,
[Typically at run time, applied by a form user:]
   entering data field values into the data fields of said first form, where the data field values are stored with the hierarchical information of the field names in their names, and
   producing an instance with data from the data field values in a hierarchical structure using a structurizer, where the hierarchical structure is determined from the field names.

In this case, the term instance covers a set of data structured according to the hierarchical data model.

Since the hierarchical information is contained in the field names for the data fields, it is easy to correct or amend the data field values. By conserving the hierarchical information in the names, it is also unnecessary to maintain a stringent structure, when storing the data field values.

The method according to the invention further includes obtaining an XML schema document from the hierarchical data model, where the XML schema document includes the expected XML schema for the instance, and parsing with the use of a parser for mutual inconsistencies between the XML schema and the instance and outputting an error message if the instance does not have the expected structure.

Ideally, parsing is not needed, since said instance is based on the field name list created by the hierarchical data model. This is one of the advantages of the invention.

Due to the hierarchical structure of the data model, the individual field names of the field name list become unique. However, the hierarchical structure of the data model can be derived from the names alone and no further information regarding the positions of the individual data elements in the data model is needed. This especially is advantageous when such a data model is used in connection with HTML-browsers, since such browsers handle data in a manner, which is flat, thereby making it difficult to preserve the hierarchical information. Having a naming convention, which preserves the hierarchical information, is therefore a great help.

### BRIEF DESCRIPTION OF THE DRAWINGS

FIG. 1 is a flow diagram according to the invention,

FIG. 2 is a form and the flat naming of data fields,

FIG. 3 is a naming according to the invention,

FIG. 4 is a short and a full notation for the XML schema,

FIG. 5 is the short notation for the data fields from FIG. 2,

FIG. 6 is the form from FIG. 2 with data entered,

FIG. 7 is the data field names and the corresponding names, and

FIG. 8 is the resulting data structure according to the invention.

### DETAILED DESCRIPTION

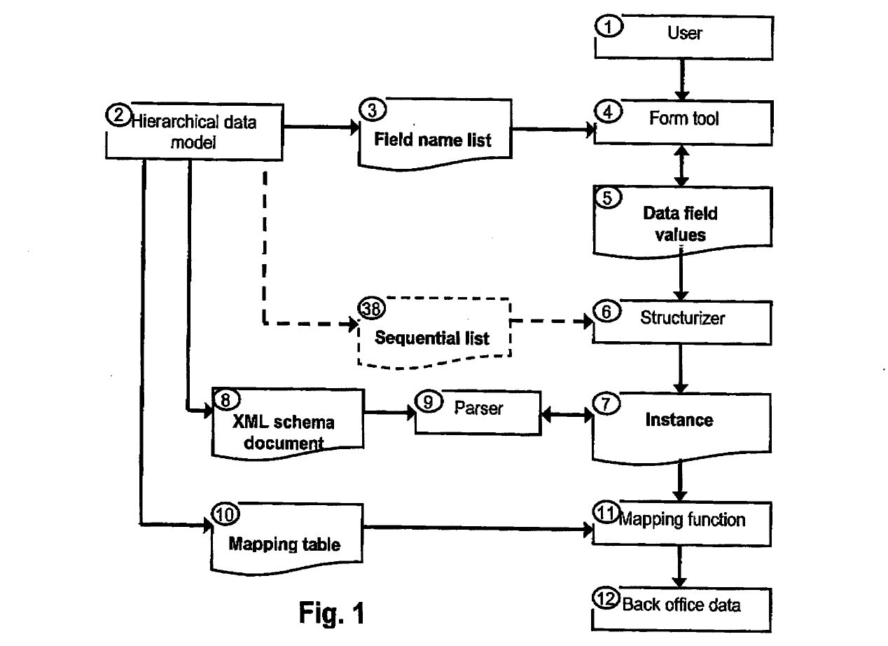

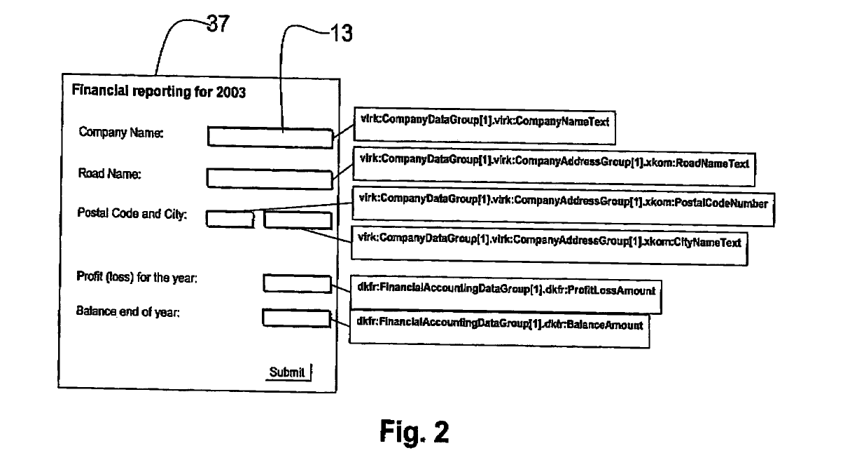

The invention will be described with reference to a simple example, where a user 1 wishes to enter some data regarding his company. FIG. 1 shows an embodiment of a flow diagram illustrating the method according to the invention. The form 37, shown in FIG. 2, of the example contains simple information such as the name of the company, road name, postal code, profit and balance for the year indicating what type of information to be entered into the individual fields, and the form 37 is shown as it would typically appear in a browser for viewing HTML. The form tool 4 is linked via a field name list 3 to a hierarchical data model 2 containing the hierarchical information for the form tool 4. The hierarchical data model 2 comprises all the related information with regard to all possible forms used by the system and is usually quite large, especially when used for governmental systems or the like. Using the field name list 3, the form tool 4 then creates the HTML code for the form 37, which allows the user to type in the relevant data.

The user 1 operating the system then enters data into the form 37 shown in FIG. 2. The form tool 4 produces a list of data field values 5. This list may have a specific structure, but due to the naming convention (which will be described in more detail later) there is no need for sorting the data field values 5, since the hierarchical information is contained in the names. A structurizer 6 is subsequently provided with the data field values 5 and converts them to an instance 7, which contains the entered data in an XML format. The instance 7 contains no information as to how it was created.

While the form tool 4 requests the field name list 3, the hierarchical data model 2 requests an XML schema document or file 8. Alternatively the XML schema document 8 is requested at an earlier time (“design time”). The XML schema document 8 contains the expected structure of the instance 7 and a parser 9 performs a comparison between the XML schema document 8 and the instance 7. If the parser 9 finds structural errors in the instance 7, it may continue to parse the instance 7 and log all errors or it may simply stop at the first error. Depending on the error method according to the invention, it may be unable to continue and stop or it may return to one or more of the previous steps in order to remedy the error.

An outer loop shown in FIG. 1 uses the hierarchical model in “reverse”. In many cases a system using the method according to the invention has to exchange data with other systems. In some cases, the instance 7 will be usable as it is, given that the other Systems use the same hierarchical model. In other cases, the other systems may use a different hierarchical model or a non-hierarchical data model. In this case a mapping function 11 requests a mapping table from the hierarchical data model 2 and the mapping function 11 produces back office data 12 according to the other data model. In this case, the term ‘back office data’ means data in the target system (the system for receiving data from the form). In the same way as for the field name list 3 and the XML schema file 9, the mapping table is requested by the hierarchical data model 2.

The field name list 3 is a simple list of the names for the data fields of the form. The names for the data fields could be arbitrarily selected without regard to the hierarchical structure. The object of the invention, however, is to preserve the hierarchical information in the naming convention. The proposed naming convention has the following format:
NS1 NSSeparator Element1Name [GroupCount] HierarchySeparator NS2 NSSeparator Element2Name [GroupCount] HierarchySeparator . . . HierarchySeparator NSn NSSeparator ElementName [ElementCount]
   where the name spaces (NS1-NSn) can be regarded as a prefix to the ElementNames in order to facilitate decentralized management of ElementNames, and the HierarchySeparator character separates the different levels of the hierarchy. The GroupCount identifies different instances of the same group definition, e.g. if the group defines an element of a list of data, where each element in the list consist of the same set of data. The ElementCount identifies different instances of the same element definition within a group. For simplicity, ElementCounts are not shown in the following examples.

Many characters could be used for the separator characters, but in this example the character “:” is used as a name space separator and the character “.” is used as a hierarchy separator. A name with three hierarchical levels would for instance look like the following:
ns1:Group1Name[1].ns2:Group2Name[1]. ns3:ElementName
   where ns1:Group1Name would be top level of the hierarchy, ns2:Group2Name would be the second level and ns3:ElementName would be the third level and indicates the actual name of the element. The above example is shown for three levels in the hierarchy, but there is of course no limit to the number of possible layers. A group may be used once or it may be used several times. In the above example, the number of times a group is used is indicated by “[1]”, where the number will be incremented for each time it is used (instance count). The element name is usually also assigned a type, where the type will have restrictions on the type of data to which the name refers to. Some names will always refer to a number, a string of letters or other specific data types. It is also possible that a name could correspond to a group of information. An address group would comprise a string for the street name and an integer for the postal code (or a specific mix of characters and numbers). Each element is thus uniquely named, while the hierarchical structure can be derived from the field name itself.

Referring to the example shown in FIG. 2 the name for the data field with the name of the company is thus:
virk:CompanyDataGroup[1]. virk:CompanyNameText

The address of the company usually comprises several different fields of information such as the road name, the postal code, etc. The names for the data fields with the address information are thus:
virk:CompanyDataGroup[1]. virk:CompanyAddressGroup[1].xkom:RoadNameText
virk:CompanyDataGroup[1].virk:CompanyAddressGroup[1].xkom:PostalCodeNumber
Virk:CompanyDataGroup[1]. virk:CompanyAddressGroup[1].xkom:CityNameText

Finally the form contains some financial information. The names for the data field with the financial information are thus:
dkfr:FinancialAccountingDataGroup[1].xkom:ProfitLossAmount
dkfr:FinancialAccountingDataGroup[1].xkom:BalanceAmount

As it appears, each of names for the data fields is thus uniquely named in a way that preserves the hierarchical information. It is also easy to expand the structure by adding new data fields. Each of the data fields are also assigned a specific data type and only data of the specified type will be accepted as input. Different types of data fields may be reused while appointing a separate name. Elements may also be reused thereby inheriting both the data type and the element name. Elements can be grouped into an united number of grouping hierarchies. Each group can be reused (referenced) in the same way as a data element, both as a type and as a data element. An element (or group) may appear once or several times within its super-group. Each element, type (and hence group) is named in one of several (unlimited) name spaces. This corresponds to the normal use of XML schemas. When progressing up/down through a grouping hierarchy, several name spaces may have been applied to the field names thereof.

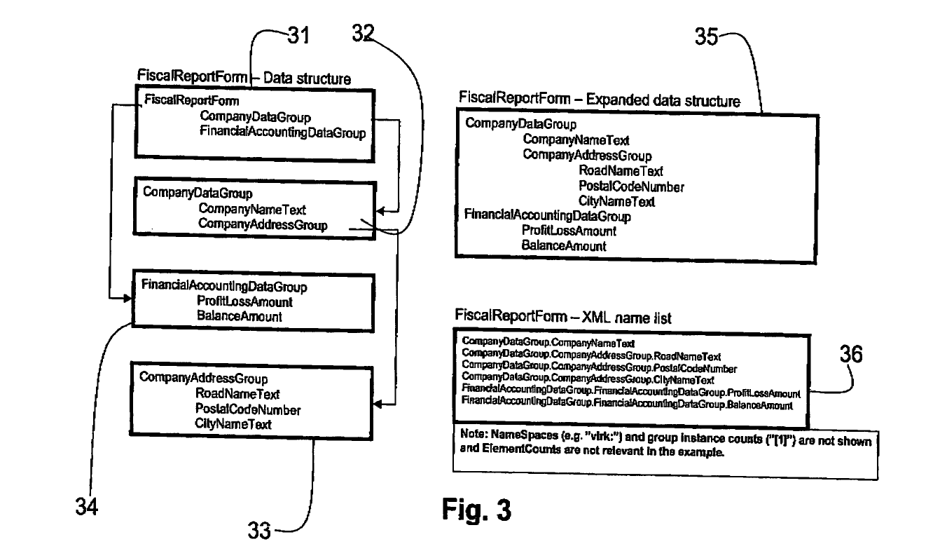

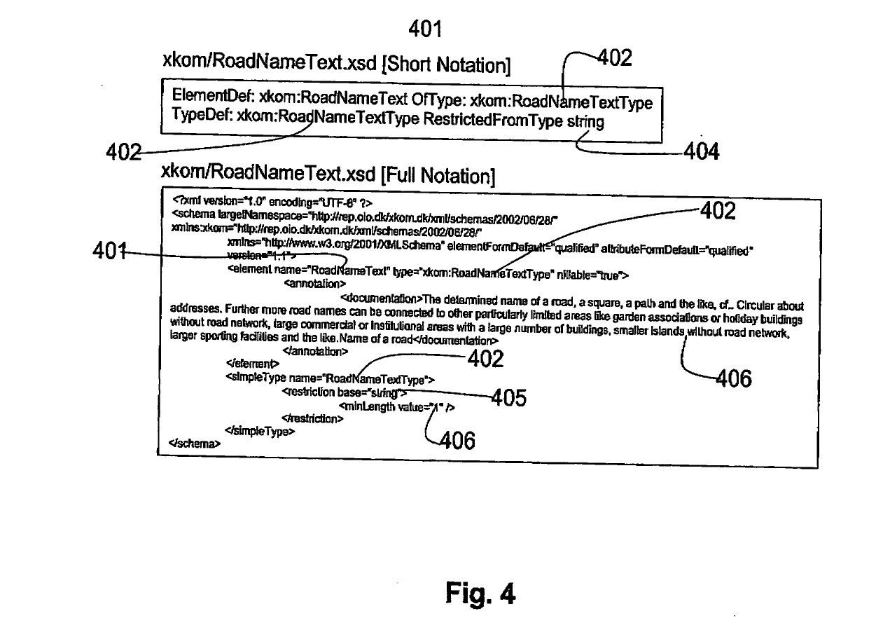

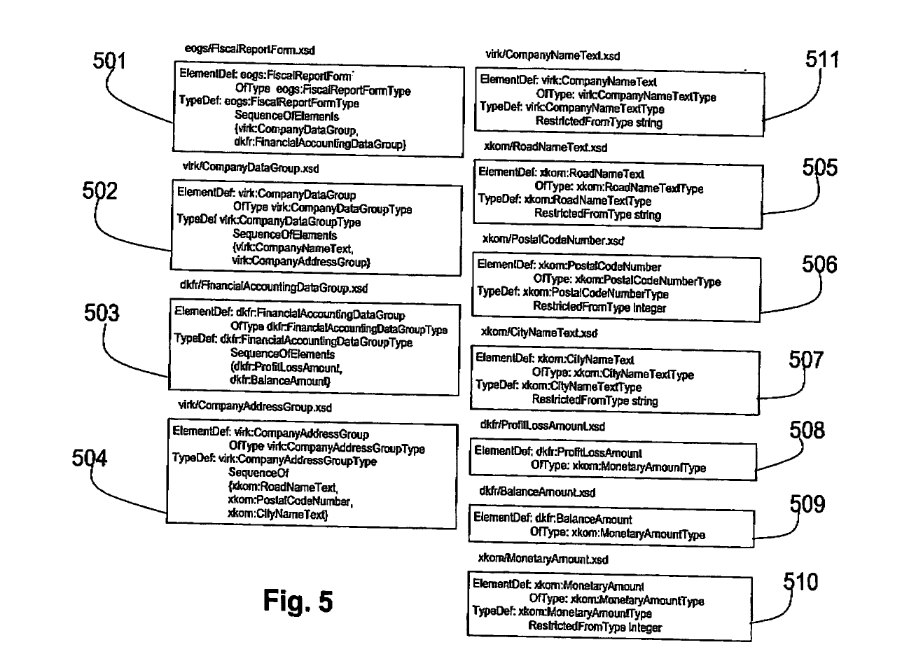

FIG. 3 illustrates the data model for the form shown in FIG. 2. Note that in this figure the name spaces (“virk:”) and the instance counts (“[1]”) are not shown for the sake of simplicity. The top level of the hierarchy shows that it is a FiscalReportForm 31 with a specific data structure. The first level of the hierarchy comprises two elements: CompanyDataGroup 32 and FinancialAccountingDataGroup 34. CompanyDataGroup 32 contains the information regarding the address and the like and FinancialAccountingDataGroup 34 contains financial information. CompanyDataGroup 32 can be expanded one additional level, corresponding to more detailed information, viz. CompanyNameText and CompanyAddressGroup 33. CompanyNameText will be the actual name of the company and CompanyAddressGroup 33 contains information on the address of the company. An important distinction is also shown here, where CompanyNameText corresponds to the name of the company and thus cannot be expanded further, while CompanyAddressGroup 33 is a group and thus comprises several fields of information. CompanyAddressGroup 33 can be expanded one additional level and thus show RoadNameText, PostalCodeNumber and CityNameText, which correspond to the address information and in return cannot be expanded any further. Likewise, FinancialAccountingDataGroup 34 may be expanded showing ProfitLossAmount and BalanceAmount. The FiscalReporForm 31 thus has an expanded data structure 35 comprising the different data elements and the hierarchical structure. Finally, this yields the XML name list 36 comprising all the names for the data fields of the form with the hierarchical information embedded in the naming convention. This is further elaborated upon in connection with FIG. 4 and FIG. 5.

FIG. 4 shows both the short notation and the full notation for the XML schema. In the XML schema, both the names and the types of the data fields 13 are defined. In the short notation, it can be seen that xkom:RoadNameText 401 is of the type xkom:RoadNameTextType 402. In the next line it is defined that xkom:RoadNameTextType 402 is of the data type string 404. The same information is provided in the full notation, which is where the XML schema is defined. There are references to URL's used with the schema as well as a version reference. The type for xkom:RoadNameText 401 is being defined as xkom:RoadNameTextType 402 and a bit further down it can be seen that xkom:RoadNameTextType 402 is a string 404. In this case, the string contains the actual name of the street. It can also be seen that the minLength 405 is one, which means that the street name must be defined and must be at least one character long. There is also documentation 406 giving a short description of the type of data that is expected to be entered into this field; in this case a suggestion on what a road name could be.

FIG. 5 shows the short notation for all the data fields in FIG. 2. On the highest level of the hierarchy is an eogs:FiscalReportForm 501. As can be seen, the type for eogs:FiscalReportForm 501 is of the eogs:FiscalReportFormType. An eogs:FiscalReportFormType is defined as a sequence of elements, which comprises a virk:CompanyDataGroup 502 and a dkfr:FinancialAccountingDataGroup 503. The virk:CompanyDataGroup 502 is user defined as a virk:CompanyDataGroupType comprising the sequence of elements; virk:CompanyNameText 511 and virk:CompanyAddressGroup 504. virk:CompanyAddressGroup 504 is again defined as being of the virk:CornpanyAddressGroupType, which comprises the sequence: xkom:RoadNameText 505, xkom:PostalCodeNumber 506 and xkom:CityNameText 507. It is seen that xkom:RoadNameText 505 is of the xkom:RoadNameTextType, which is a string, xkom:PostalCodeNumber 506 is of the xkom:PostalCodeNumberType, which is an integer (in this case) and xkom:CityNameText 507 is of the xkom:CityNameTextType, which also is a string dkfr:FinancialAccountingDataGroup 503 is defined as being of the dkfr:FinancialAccountingDataGroupType, which is a sequence of elements comprising dkfr:ProfitLossAmount 508 and dkfr:BalanceAmount 509. Both dkfr:ProfitLossAmount 508 and dkfr:BalanceAmount 509 are of the xkom:MonetaryAmountType 510 and are defined as being integers.

As seen from FIG. 5, the data fields may be defined as groups within groups and the types can be defined individually or as a common, which can be used for several data fields.

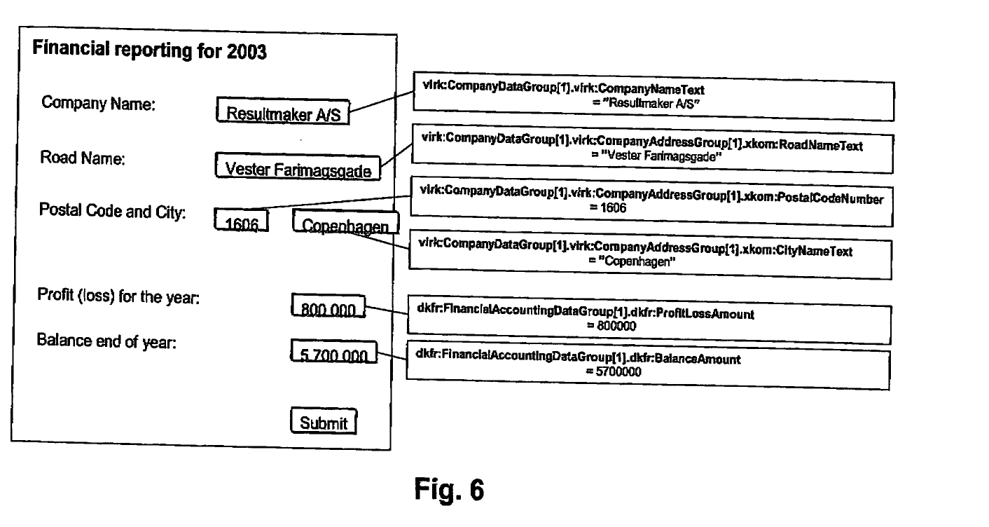

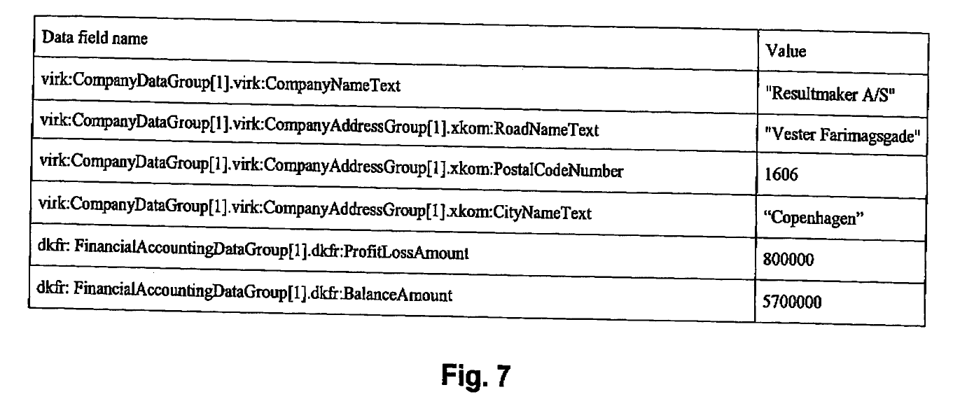

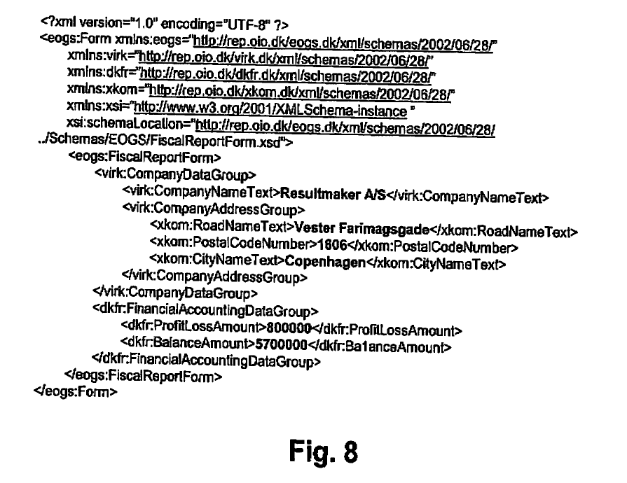

FIG. 6 shows the form from FIG. 2 with information entered and FIG. 7 is a table showing the field names and the corresponding data. Finally, FIG. 8 shows the completed instance 7.

The above example was shown for a single form 37 only. In many cases, however, There will be a need for using several different forms. One example of this could be where the user wishes to build a new house. He will need to obtain several different permits, e.g. a building permit and other permits, and hence there is a need to fill in several different forms. As the user progresses through the different forms, information is accumulated, As indicated by the bidirectional arrow between 4 and 5 in FIG. 1, information, which is already known, will be duplicated to the next form, and the user is therefore not required to enter this information more than once. On the other hand, if the user spots an error, or if one specific form needs to have different information, it is also possible to correct the error or indicate different information in one or more specific forms.

In the above description in connection with FIG. 2, it was mentioned that a field name list 3 and an XML schema document 8 were requested from the hierarchical data model 2. It is within the scope of the invention that the field name list 3 and the XML schema document 8 are generated upon the request, resulting in a very dynamic system. It may, however, be impractical due to the fact that this procedure will have response times that are too long. More conveniently, the method according to the invention is split into “a design time” and “a run time”. During the design time, the hierarchical data model 2 is modified and when it is certified that it produces the correct results, all possible field name lists 3, XML schema documents 8 and mapping tables 10 are produced and locked. During run time, when a field name list 3, an XML schema document 8 or a mapping table 10 are requested, they are selected from these locked field name lists 3, XML schema documents 8 and mapping tables 10. At a later time, when revisions are needed, the hierarchical data model 2 is updated and new field name lists 3, XML schema documents 8 and mapping tables 10 are produced and locked.

As mentioned above, generally there are no sequential requirements in the data structures used. This is particularly true for the data field values 5, since the data is added as a consequence of the graphical layout of the form, the order the user enters the data or as a consequence of corrections or amendments of data in connection with later forms. Due to the hierarchical naming, in many cases it will not matter which order the data is stored as long as the hierarchy is preserved in the names. On the other hand, it is sometimes useful or necessary to have some sequential information (element X has to be before element Y). This can be included in several different ways, e.g. by including the information with the field name list 3 or by using a sequential list 38 as indicated in FIG. 1. When the form tool 4 subsequently generates or amends the data field values 5 or when the structurizer 6 generates the instance 7, the sequential restrictions may be applied.

The above description of the invention reveals that it is obvious that it can be varied in many ways. Such variations are not to be considered a deviation from the scope of the invention, and all such modifications which are obvious to persons skilled in the art are also to be considered comprised by the scope of the succeeding claims.

1. A method of entering, structuring, storing and transferring data using a hierarchical data model and flat forms including:
selecting a first form (37) from a plurality of forms, said first form (37) comprising a number of fields, each having an individual field name,
obtaining a field name list (3) from a hierarchical data model (2), where the field names of the field name list (3) contain information on the data types for the fields (13) of said first form (37) as well as hierarchical information, said field names being defined in accordance with a predefined naming convention,
creating by use of the form tool (4) and the information in the field name list (3) the HTML-code for displaying said first form (37) in an HTML browser,
entering data field values (5) into the data fields of said first form (37), where the data field values (5) are stored with the hierarchical information of the field names in their names, and
producing an instance (7) with data from the data field values (5) in a hierarchical structure using a structurizer (6), where the hierarchical structure is determined from the field names.

2. A method of claimed in claim 1 further including:
obtaining an XML schema document (8) from the hierarchical data model (2), where the XML schema document (8) includes the expected XML schema for the instance (7).

3. A method as claimed in claim 2 further including:
parsing with the use of a parser (9) for mutual inconsistencies between the XML schema (8) and the instance (7) and outputting an error message if the instance (7). does not have the expected structure.

4. A method as claimed in claim 3 further including:
selecting, by the use of a form tool (4), a second form (37) from a plurality of forms,
obtaining a second field name list (3) from the hierarchical data model (2),
creating by use of the form tool (4) and the information in said second field name list (4) the HTML-code for displaying said second form (37) in an HTML browser,
duplicating in said second form (37) data field values (5) from said first form, whose fieldnames correspond to the fields of said second form (37),
entering data field values (5) into the data fields of said second form (37), where the data field values (5) are stored with hierarchical information in their names, and
outputting an instance (7) with data from the data field values (5) in a hierarchical structure using a structurizer (6), where the hierarchical structure is determined from the names.

5. A method as claimed in claim 4 further including:
obtaining a new XML schema document (8) from the hierarchical data model (2), where the new XML schema document (8) includes the expected XML schema for the instance (7).

6. A method as claimed in claim 5 further comprising
parsing with the use of a parser (9) the new XML schema document (8) against the instance (7) and outputting an error message if the instance does not have the expected structure.

7. A method according to claim 1 wherein the naming convention comprises name spaces and separator characters having the following structure:
NS1 NSSeparator Element1Name [GroupCount] HierarchySeparator NS2 NSSeparator Element2Name [GroupCount] HierarchySeparator . . . HierarchySeparator NSn NSSeparator ElementName [ElementCount]
where the name spaces (NS1-NSn) are prefixes to the ElementNames, the GroupCount identifies multiple occurrences of the same group of data, the hierarchy separator character (HierarchySeparator) separates the different levels of the hierarchy, and the ElementCount identifies multiple occurrences of the same element within a group.

8. A method according to claim 1 where sequential information for the data field values are contained in the field name list (3) or in a separate sequential list (38), where the sequential information includes information on required sequences for two or more of the data field values (5), and where the sequential information is added to the field name list (3) by the hierarchical data model (2), or the sequential list (38) is created by the hierarchical data model (2).

9. A method of entering, structuring, storing and transferring data using a hierarchical data model and flat forms including:
creating a first form (37) by use of a form tool (4), said first form (37) comprising a number of fields, each having an individual field name,
obtaining a field name list (3) from a hierarchical data model (2), where the field names of the field name list (3) contain information on the data types for the fields (13) of said first form (37) as well as hierarchical information, said field names being defined in accordance with a predefined naming convention,
creating by use of the form tool (4) and the information in the field name list (3) the HTML-code for displaying said first form (37) in an HTML browser,
entering data field values (5) into the data fields of said first form (37), where the data field values (5) are stored with the hierarchical information of the field names in their names, and
producing an instance (7) with data from the data field values (5) in a hierarchical structure using a structurizer (6), where the hierarchical structure is determined from the field names.
